(19) United States
(12) Patent Application Publication
(10) Pub. No.: US 2018/0018970 A1
(43) Pub. Date: Jan. 18, 2018

(54) NEURAL NETWORK FOR RECOGNITION OF SIGNALS IN MULTIPLE SENSORY DOMAINS

(71) Applicant: Google Inc., Mountain View, CA (US)

(72) Inventors: Lawrence Heyl, Colchester, VT (US); Rajeev Conrad Nongpiur, Palo Alto, CA (US)

(21) Appl. No.: 15/211,791

(22) Filed: Jul. 15, 2016

(51) Int. Cl. G10L 17/18; G10L 21/028; G10L 17/08; G10L 25/57; G06K 9/00

(52) U.S. Cl. CPC G10L 17/18; G10L 25/57; G06K 9/00268; G10L 17/08; G10L 21/028

(57) ABSTRACT

Apparatus and method for training a neural network for signal recognition in multiple sensory domains, such as audio and video domains, are provided. For example, an identity of a speaker in a video clip may be identified based on audio and video features extracted from the video clip and comparisons of the extracted audio and video features to stored audio and video features with their associated labels obtained from one or more training video clips. In another example, a direction of sound propagation or a location of a sound source in a video clip may be determined based on the audio and video features extracted from the video clip and comparisons of the extracted audio and video features to stored audio and video features with their associated direction or location labels obtained from one or more training video clips.

### BACKGROUND

Signal recognition has been traditionally performed on signals arising from single domains, such as pictures or sounds. The recognition of a particular image of a person as being a constituent of a given picture and a particular utterance of a speaker as being a constituent of a given sound has been typically accomplished by separate analyses of pictures and sounds.

### BRIEF SUMMARY

According to an embodiment of the disclosed subject matter, a method of determining the identity of a speaker includes reading a first video clip for training a neural network, the first video clip including a first audio content and a first video content, the first audio content including a prescribed utterance of a first speaker who is identified by a speaker identifier and the first video content including an image of the first speaker; extracting a first audio feature from the first audio content; extracting a first video feature from the first video content; obtaining, by the neural network, an authentication signature based on the first audio feature and the first video feature; storing the authentication signature and the speaker identifier that corresponds to the authentication signature in a memory; reading a second video clip including a second audio content and a second video content, the second audio content including an utterance of a second speaker who is not pre-identified and the second video content including an image of the second speaker; extracting a second audio feature from the second audio content; extracting a second video feature from the second video content; obtaining, by the neural network, a signature of the second speaker based on the second audio feature and the second video feature; determining, by the neural network, a difference between the signature of the second speaker and the authentication signature; and determining, by the neural network, whether the second speaker in the second video clip is the same as the first speaker in the first video clip based on the difference between the signature of the second speaker and the authentication signature.

According to an embodiment of the disclosed subject matter, an apparatus for determining the identity of a speaker in a video clip includes a memory and a processor communicably coupled to the memory. In an embodiment, the processor is configured to execute instructions to read a first video clip for training a neural network, the first video clip including a first audio content and a first video content, the first audio content including a prescribed utterance of a first speaker who is identified by a speaker identifier and the first video content including an image of the first speaker; extract a first audio feature from the first audio content; extract a first video feature from the first video content; obtain an authentication signature based on the first audio feature and the first video feature; store the authentication signature and the speaker identifier that corresponds to the authentication signature in the memory; read a second video clip including a second audio content and a second video content, the second audio content including an utterance of a second speaker who is not pre-identified and the second video content including an image of the second speaker; extract a second audio feature from the second audio content; extract a second video feature from the second video content; obtain a signature of the second speaker based on the second audio feature and the second video feature; determine a difference between the signature of the second speaker and the authentication signature; and determine whether the second speaker in the second video clip is the same as the first speaker in the first video clip based on the difference between the signature of the second speaker and the authentication signature.

According to an embodiment of the disclosed subject matter, a method of estimating the direction of a sound includes reading a first video clip for training a neural network, the first video clip including a first audio content and a first video content; extracting a first audio feature from the first audio content; extracting a first video feature from the first video content; determining, by the neural network, a label indicating at least a direction of a first sound from a sound source in the first video clip based on the first audio feature and the first video feature; storing the first audio feature and the first video feature corresponding to the label in a memory; reading a second video clip including a second audio content and a second video content, the second audio content including a second sound from the sound source, wherein the direction of the second sound is not pre-identified; extracting a second audio feature from the second audio content; extracting a second video feature from the second video content; and obtaining, by the neural network, a probable direction of the second sound based on a comparison of the second audio feature to the first audio feature and a comparison of the second video feature to the first video feature.

According to an embodiment of the disclosed subject matter, an apparatus for estimating the direction of a sound in a video clip includes a memory and a processor communicably coupled to the memory. In an embodiment, the processor is configured to execute instructions to read a first video clip for training a neural network, the first video clip including a first audio content and a first video content; extract a first audio feature from the first audio content; extract a first video feature from the first video content; determine a label indicating at least a direction of a first sound from a sound source in the first video clip based on the first audio feature and the first video feature; store the first audio feature and the first video feature corresponding to the label in a memory; read a second video clip including a second audio content and a second video content, the second audio content including a second sound from the sound source, wherein the direction of the second sound is not pre-identified; extract a second audio feature from the second audio content; extract a second video feature from the second video content; and obtain a probable direction of the second sound based on a comparison of the second audio feature to the first audio feature and a comparison of the second video feature to the first video feature.

According to an embodiment of the disclosed subject matter, means for determining the identity of a speaker are provided, which include means for reading a first video clip for training a neural network, the first video clip including a first audio content and a first video content, the first audio content including a prescribed utterance of a first speaker who is identified by a speaker identifier and the first video content including an image of the first speaker; means for extracting a first audio feature from the first audio content; means for extracting a first video feature from the first video content; means for obtaining an authentication signature based on the first audio feature and the first video feature; means for storing the authentication signature and the speaker identifier that corresponds to the authentication signature in a memory; means for reading a second video clip including a second audio content and a second video content, the second audio content including an utterance of a second speaker who is not pre-identified and the second video content including an image of the second speaker; means for extracting a second audio feature from the second audio content; means for extracting a second video feature from the second video content; means for obtaining a signature of the second speaker based on the second audio feature and the second video feature; means for determining a difference between the signature of the second speaker and the authentication signature; and means for determining whether the second speaker in the second video clip is the same as the first speaker in the first video clip based on the difference between the signature of the second speaker and the authentication signature.

According to an embodiment of the disclosed subject matter, means for estimating the direction of a sound are provided, which include means for reading a first video clip for training a neural network, the first video clip including a first audio content and a first video content; means for extracting a first audio feature from the first audio content; means for extracting a first video feature from the first video content; means for determining a label indicating at least a direction of a first sound from a sound source in the first video clip based on the first audio feature and the first video feature; means for storing the first audio feature and the first video feature corresponding to the label in a memory; means for reading a second video clip including a second audio content and a second video content, the second audio content including a second sound from the sound source, wherein the direction of the second sound is not pre-identified; means for extracting a second audio feature from the second audio content; means for extracting a second video feature from the second video content; and means for obtaining a probable direction of the second sound based on a comparison of the second audio feature to the first audio feature and a comparison of the second video feature to the first video feature.

Additional features, advantages, and embodiments of the disclosed subject matter may be set forth or apparent from consideration of the following detailed description, drawings, and claims. Moreover, it is to be understood that both the foregoing summary and the following detailed description are illustrative and are intended to provide further explanation without limiting the scope of the claims.

### BRIEF DESCRIPTION OF THE DRAWINGS

The accompanying drawings, which are included to provide a further understanding of the disclosed subject matter, are incorporated in and constitute a part of this specification. The drawings also illustrate embodiments of the disclosed subject matter and together with the detailed description serve to explain the principles of embodiments of the disclosed subject matter. No attempt is made to show structural details in more detail than may be necessary for a fundamental understanding of the disclosed subject matter and various ways in which it may be practiced.

FIG. 1 shows a block diagram illustrating an example of an audio/video system.

FIG. 2 shows a flowchart illustrating an example of a process for generating audio and video features for training a neural network to determine the identity of a speaker.

FIG. 3 shows a flowchart illustrating an example of a process for generating and storing authentication signatures of one or more speakers for training the neural network to determine the identity of a speaker.

FIG. 4 shows a flowchart illustrating an example of a process for determining the identity of a speaker by comparing a signature obtained from the audio and video features of the speaker to the stored authentication signatures.

FIG. 5 shows a flowchart illustrating an example of a process for training a neural network to estimate a direction of arrival of a sound.

FIG. 6 shows a flowchart illustrating an example of a process for estimating the direction of arrival of a sound by using the trained neural network.

FIG. 7 shows an example of a computing device according to embodiments of the disclosed subject matter.

FIG. 8 shows an example of a sensor according to embodiments of the disclosed subject matter.

### DETAILED DESCRIPTION

It is desirable to recognize signals of different types in composite domains rather than separate domains for improved efficiency. Signals of different types in different domains may be recognized for various purposes, for example, to determine the identity of a person or to estimate the direction of a sound or the location of a speaker or sound source based on audio and video features extracted from a video clip that includes a soundtrack as well as a video content. Although various examples described below relate to recognition of audio and video signals in composite audio/video domains, the principles of the disclosed subject matter may be applicable to other types of signals indicative of measurable or quantifiable characteristics. For example, signals representing quantifiable characteristics based on sensory inputs, such as tactile, olfactory, or gustatory inputs, may also be analyzed according to embodiments of the disclosed subject matter. As alternatives or in addition, the principles of the disclosed subject matter may be applicable to signals produced by various types of electrical, mechanical or chemical sensors or detectors, such as temperature sensors, carbon dioxide detectors or other types of toxic gas detectors, infrared sensors, ultraviolet sensors, motion detectors, position sensors, accelerometers, gyroscopes, compasses, magnetic sensors, Reed switches, or the like.

In some implementations, recognition of signals from different types of sensors may be accomplished by a neural network. A sensor may generate an output that is indicative of a measured quantity. For example, a video camera may respond to received light over prescribed bands of sensitivity and provide a map of illumination data based on a sampling of the received light over space and time. Likewise, a microphone may respond to received sound over a frequency range and provide a map of perturbations in atmospheric pressure based on a sampling of the received sound over time. A stereo system of two or more microphones may provide a map of perturbations in atmospheric pressure based on a sampling of the received sound over space and time. Thus, the domain of the video camera is illumination over a region of space and time, and the domain of the stereo microphone system is atmospheric pressure perturbation over a region of space and time.

As a generalization, each sensor S may have its own domain D, such that its input to the neural network is S(D). The neural network may be trained to perform recognition of the signal S(D). The neural network NN may apply an activation function A to a linear combination of a data vector and a weight vector W to generate a result R:

R=NN[A(S(D)·W)]

Assuming that a signal recognition system has a total number of i domains and a total number of j sensors, the domains may be denoted as D₁, D₂, . . . Dᵢ and the sensors may be denoted as S₁, S₂, . . . Sⱼ. The result R may be considered as a composition of multiple neural networks each operating in a respective domain:

R=NN[D₁]·NN[D₂]· . . . NN[Dᵢ]

In addition or as an alternative, the result R may be formed by the operation of another neural network on the outputs of the individual neural networks in order to achieve a reduction in dimensionality for recognition:

R=NN₁[NN₂[D₁], NN₃[D₂], . . . ,NNⱼ[Dᵢ]]

where each of NN₁, NN₂, . . . NNⱼ is a unique neural network.

According to embodiments of the disclosed subject matter, a single neural network may be trained for signal recognition in a composite domain even if signals of different types belong to different domains:

R=NN [D₁,D₂, . . . ,Dᵢ]

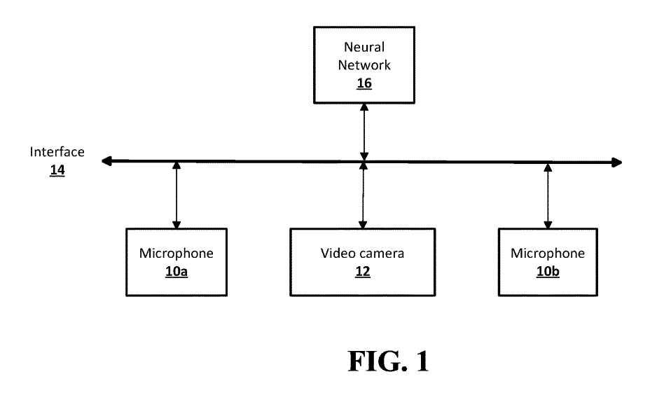

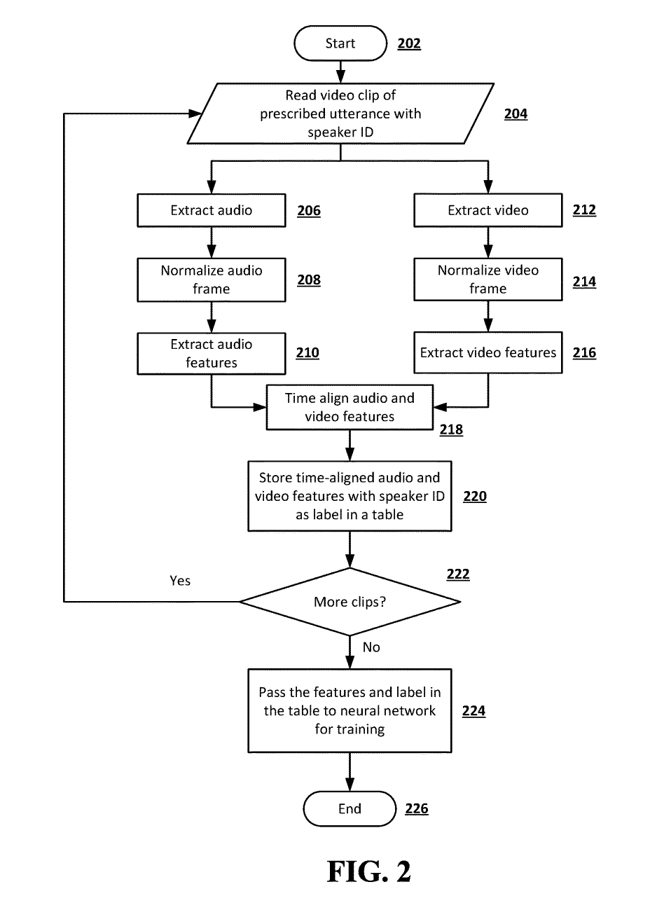

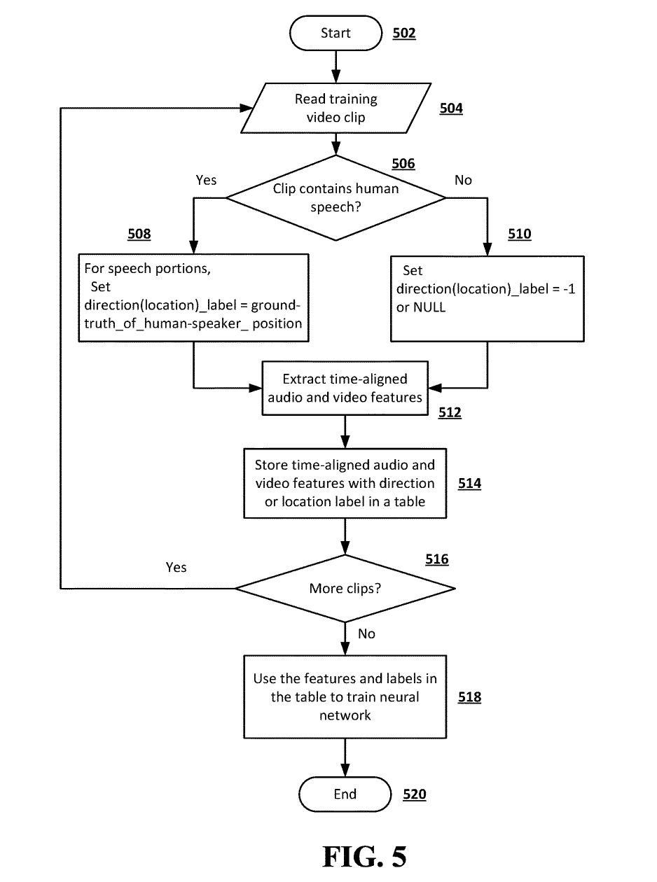

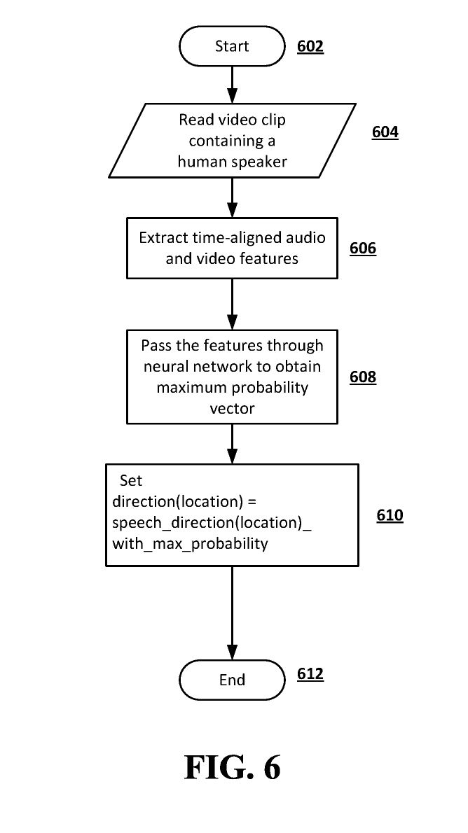

Two specific examples of signal recognition in the audio/video domains performed by an audio/video system of FIG. 1 will be described in detail below. One of the examples relates to determining the identity of a speaker in a video clip that includes a soundtrack, with reference to the flowcharts of FIGS. 2-4. The other example relates to estimating the direction of arrival of a sound such as a human speech or the location of a sound source or speaker based on audio/video features extracted from a video clip that includes a soundtrack, with reference to the flowcharts of FIGS. 5-6.

FIG. 1 shows a block diagram illustrating an example of an audio/video system which includes two microphones 10a and 10b and a video camera 12. In some implementations, the microphones 10a and 10b may be integral parts of the video camera 12. Two or more microphones may be implemented for stereo sound detection, although a single microphone may be provided in some implementations if the soundtrack of a video clip produced by the audio/video system only includes a single sound channel. As shown in FIG. 1, the microphones 10a and 10b and the video camera 12 are coupled to a neural network 16 through an interface 14. In some implementations, more than two microphones may be implemented to obtain more precise estimations of the location of a sound source or the direction of sound propagation.

### Example One

### Identification of a Speaker Based on Authentication Signatures

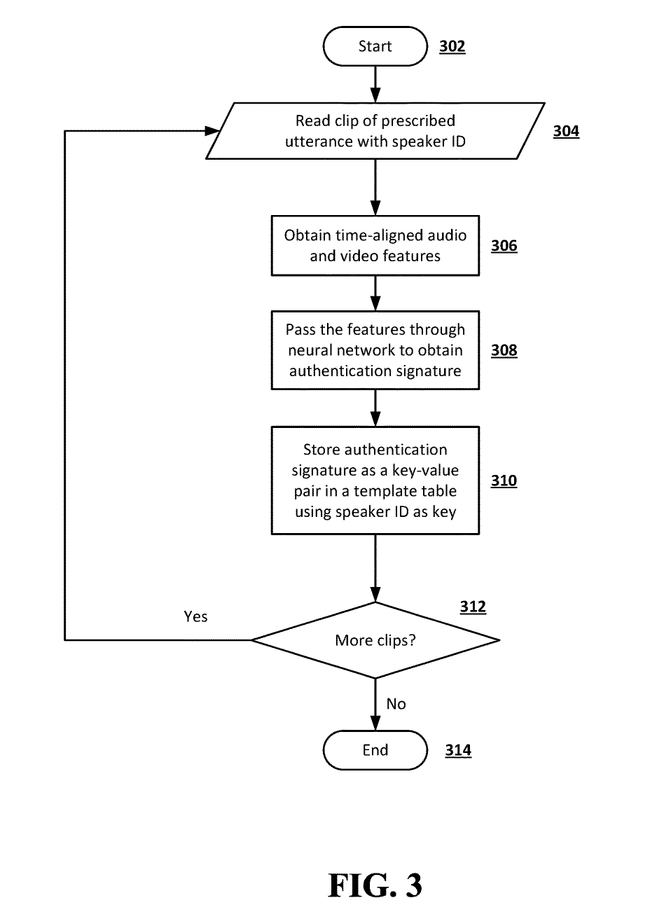

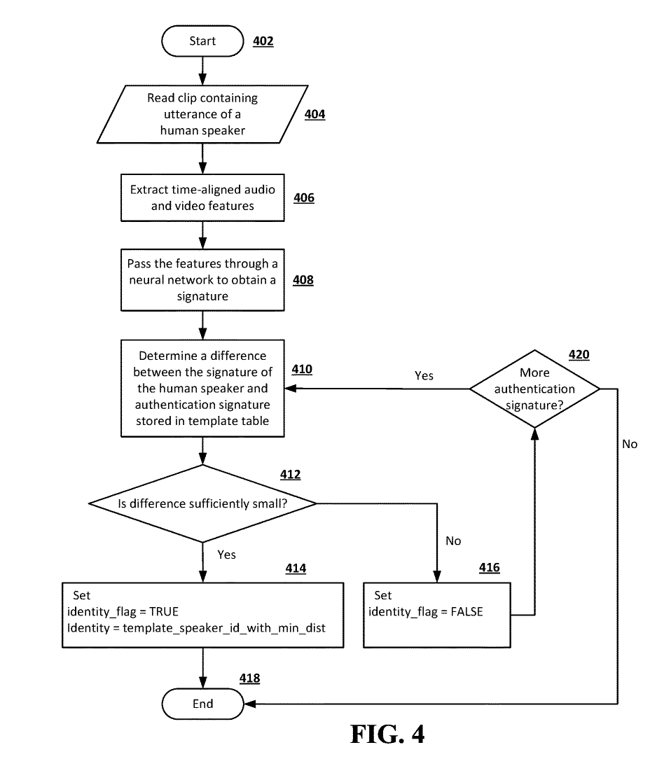

In this example, the audio and video features are transmitted to a neural network to determine the identity of a person. In one implementation, speaker identification may involve three phases, including a first phase of generating audio/video features from video clips that include prescribed utterances of one or more known speakers to train the neural network, as illustrated in FIG. 2, a second phase of generating and storing authentication signatures of one or more known speakers for validation, as illustrated in FIG. 3, and a third phase of determining the identity of a human speaker in a video stream by determining whether that person has an audio/video signature that has a sufficiently close match to one of the stored authentication signatures, as illustrated in FIG. 4.

FIG. 2 is a flowchart illustrating an example of a process for generating audio and video features for training a neural network in the first phase of determining the identity of a speaker. The process starts in block 202, and a video clip that includes a prescribed utterance of a speaker with a speaker identifier is read in block 204. The video clip is a training clip that includes both audio and video contents featuring a speaker with a known identity for training a neural network. In the implementation shown in FIG. 2, the audio and video contents are processed separately in parallel to extract audio and video features, respectively, before the extracted audio and video features are time-aligned and combined. In an alternative implementation, the audio and video contents may be processed serially. The audio contents may be processed before the video contents or vice versa. In FIG. 2, the audio content may be extracted from the video clip in block 206, and the audio frames for the audio content may be normalized in block 208 in manners known to persons skilled in the art. In block 210, audio features may be extracted from the audio content in the normalized audio frames.

As used herein, “features” are efficient numerical representations of signals or characteristics thereof for training a neural network in one or more domains. An audio “feature” may be one of various expressions of a complex value representing an extracted audio signal in a normalized audio frame. For example, the feature may be an expression of a complex value with real and imaginary components, or with a magnitude and a phase. The magnitude may be expressed in the form of a linear magnitude, a log magnitude, or a log-mel magnitude as known in music, for example.

In FIG. 2, the video content of the video clip may be extracted in block 212, and the video frames for the video content may be normalized in block 214 in manners known to persons skilled in the art. The video content may include images of the speaker whose prescribed utterance is recorded as part of the audio content of the video clip. In block 216, video features may be extracted from the video content in the normalized video frames. Like an audio feature, a video feature may be a numerical representation of a video signal in an efficient format for training a neural network. For example, if a video signal is represented by a complex value, then a video feature may be an expression of the complex value with real and imaginary components, or with a magnitude and a phase. Various other expressions of video signals may be used as video features for efficient training of the neural network.

In FIG. 2, after the audio features are extracted in block 210 and the video features are extracted in block 216, the audio and video features may be time-aligned in block 218. In some instances, the audio and video contents in the same video clip may not be framed at the same rate, and the audio and video frames may not be time-aligned with respect to each other. For these types of video clips, the extracted audio features and the extracted video features may be time-aligned in block 218 such that the audio and video features may be processed by a neural network in a composite audio-video domain. In FIG. 2, after the extracted audio and video features are time-aligned in block 218, the time-aligned audio and video features may be stored with the speaker identifier as a label in an organized format, such as a table in block 220. Because the video clip that is read in block 204 is used as a training clip for training the neural network for determining the identity of a human speaker in another video clip, the identity of the speaker in the training video is known and may be used as a label associated with the extracted and time-aligned audio and video features in block 220.

After the extracted and time-aligned audio and video features are stored along with the speaker identifier as a label in block 220, a determination is made as to whether an additional video clip is to available to be read in block 222. If it is determined that an additional video clip is to available to be read for training the neural network in block 222, then the processes of extracting audio and video features from the additional video clip, time-aligning the extracted audio and video features, and storing the time-aligned audio and video features with the associated speaker identifier as a label in blocks 204-220 are repeated, as shown in FIG. 2.

In some implementations, two or more video clips featuring the same speaker may be used to train the neural network for determining the identity of the speaker. For example, two or more training clips each featuring a slightly different speech and a slightly different pose of the same speaker may be provided to train the neural network to recognize or to determine the identity of the speaker who is not pre-identified in a video stream that is not part of a training video clip. In some implementations, additional video clips featuring different speakers may be provided. In these implementations, audio and video features may be extracted from the audio and video contents, time-aligned, and stored along with their associated speaker identifiers as labels in a table that includes training data for multiple speakers. In some implementations, more than one training video clip may be provided for each of the multiple speakers to allow the neural network to differentiate effectively and efficiently between the identities of multiple speakers in a video stream that is not part of a training video clip.

If it is determined that no additional training video clip is to be read in block 222, the audio and video features and the associated labels in the table are passed to the neural network for training in block 224, and the first phase of training the neural network for identifying a human speaker as illustrated in FIG. 2 concludes in block 226. In some implementations, the neural network may be a deep neural network (DNN) that includes multiple neural network layers. In some implementations, in addition or as alternatives to the DNN, the neural network may include one or more long-short-term memory (LSTM) layers, one or more convolutional neural network (CNN) layers, or one or more local contrast normalization (LCN) layers. In some instances, various types of filters such as infinite impulse response (IIR) filters, linear predictive filters, Kalman filters, or the like may be implemented in addition to or as part of one or more of the neural network layers.

In some implementations, in order to generate additional data for training the neural network, the video features extracted from the video content of one speaker may be time-aligned with the audio features extracted from the audio content of another speaker to generate a new set of data with associated labels corresponding to the identity of the speaker who provided the video content and the identity of the other speaker who provided the audio content. Such new sets of data with their associated labels may be entered into a table for cross-referencing of the identities different speakers. By using these sets of data with cross-referencing of different speakers, the neural network may be trained to recognize which human utterance is not associated with a given video image, for example. In some implementations, time-alignment of audio and video features of different speakers may be achieved by using warping algorithms such as hidden Markov models or dynamic time warping algorithms known to persons skilled in the art. In some implementations, the neural network architecture may be a deep neural network with one or more LCN, CNN, or LSTM layers, or any combination thereof.

FIG. 3 is a flowchart illustrating an example of a process for generating and storing authentication signatures of one or more speakers for training a neural network in the second phase of identification of a speaker. The process starts in block 302, and a video clip that includes a prescribed utterance of a speaker with a speaker identifier is read in block 304. The video clip may be a training clip which includes both audio and video contents similar to the example shown in FIG. 2 and described above. In FIG. 3, time-aligned audio and video features are obtained from the video clip in block 306 and then passed through the neural network to obtain an authentication signature in block 308. In this phase, authentication signatures are generated for speakers of known identities for identification purposes. The authentication signature of a speaker is unique to that speaker based on the extracted audio and video features from one or more training video clips that include prescribed utterances of that speaker.

The authentication signature of a given speaker may be stored in a template table for training the neural network. In one implementation, each authentication signature and its associated label, that is, the speaker identifier, may be stored as a key-value pair in a template table, as shown in block 310. The speaker identifier or label may be stored as the key and the authentication signature may be stored as the value in the key-value pair, for example. Multiple sets of key-value pairs for multiple speakers may be stored in a relational database. The authentication signatures and the labels indicating the corresponding speaker identities of multiple speakers may be stored in a database in various other manners as long as the authentication signatures are correctly associated with their corresponding labels or speaker identities.

After a given key-value pair is stored in block 310, a determination is made as to whether an additional video clip is available to be read in block 312. If an additional video clip is available to be read for obtaining an additional authentication signature, then the process steps in blocks 304-310 are repeated to obtain the additional authentication signature, as shown in FIG. 3. If no additional video clip is available to be read, then the second phase of training the neural network for identifying a human speaker as illustrated in FIG. 3 concludes in block 314. In some implementations, several training video clips, for example, three or more video clips, that contain prescribed utterances of the same speaker with a known identity may be provided to the neural network, such that multiple authentication signatures may be extracted from that speaker for identification purposes.

FIG. 4 is a flowchart illustrating an example of the third phase of a process for identifying a human speaker in a video stream by comparing a signature obtained from the audio and video features of the human speaker to the stored authentication signatures. The process starts in block 402, and a video clip that includes an utterance of a human speaker is read in block 404. Unlike the training video clips used in the first and second phases as illustrated in FIGS. 2 and 3 for training the neural network, the video clip that is read in block 404 of FIG. 4 may include a video stream containing voices and images of a human speaker who is not pre-identified. In some instances, the audio frames which include the audio content and the video frames which include the video content may have different frame rates and not be aligned with each other. The audio and video features may be extracted respectively from the audio and video frames of the video clip and time-aligned with one another in block 406. In block 408, the time-aligned audio and video features are passed through the neural network, which has been trained according to the processes described above with respect to FIGS. 2 and 3, to obtain a signature of the speaker appearing in the non-training video clip that has been read in block 404 of FIG. 4. In some implementations, the signature of the human speaker in a non-training video clip may be obtained in the same manner as the authentication signature obtained from audio and video features extracted from a training video clip as shown in FIGS. 2 and 3.

As described above with respect to FIG. 3, authentication signatures and their corresponding labels or speaker identities obtained from training video clips that contain prescribed utterances of human speakers with known identities have been stored as key-value pairs in a template table, in which each speaker identifier or label is stored as a key and each authentication signature is stored as a value. In FIG. 4, the signature of the human speaker obtained from the non-training video clip in block 408 is compared to an authentication signature stored in the template table, and a difference between the signature of the human speaker and the authentication signature stored in the template table is determined in block 410. The signature of the human speaker and the authentication signature may have the same number of bits, and the difference between the signature of the human speaker and the authentication signature stored in the template table may be determined by computing a Hamming distance between the signature of the human speaker and the authentication signature, for example.

In block 412, a determination is made as to whether the difference between the signature of the human speaker and the authentication signature is sufficiently small. As known to persons skilled in the art, the Hamming distance between two binary strings is zero if the two binary strings are identical to each other, whereas a large Hamming distance indicates a large number of mismatches between corresponding bits of the two binary strings. In some implementations, the determination of whether the difference between the signature of the human speaker and the authentication signature is sufficiently small may be based on determining whether the Hamming distance between the two signatures is less than or equal to a predetermined threshold distance. For example, if the signature of the human speaker and the authentication signature each comprise a 16-bit string, the difference between the two signatures may be deemed sufficiently small if the Hamming distance between the two strings is 2 or less.

If it is determined that the difference between the signature of the human speaker and the authentication signature is sufficiently small in block 412, then the identity of the human speaker in the non-training video clip may be determined based on a complete or at least a substantial match between the two signatures. In some implementations, an identity flag of the human speaker in the non-training video clip may be set as identity_flag=TRUE, and the identity of the human speaker may be set to equal to the speaker identifier associated with the authentication signature having the smallest Hamming distance from the signature of the human speaker, that is, identity=template_speaker_id_with_min_dist, as shown in block 414. After the identity of the human speaker is determined in block 414, the process concludes in block 418. On the other hand, if it is determined that the difference between the signature of the human speaker and the authentication signature is not sufficiently small in block 412, then the identity flag may be set as identity_flag=FALSE, indicating a mismatch between the two signatures, as shown in block 416.

As described above, in some implementations, more than one authentication signature may be associated with a given speaker identifier in the template table. The signature of a human speaker in a non-training video clip may match one but not the other authentication signatures associated with that speaker identifier stored in the template table. The identity of the human speaker may be set to equal to that speaker identifier as long as one of the authentication signatures is a sufficiently close match to the signature of the human speaker.

If the template table stores authentication signatures associated with multiple speaker identifiers, the process of determining the difference between the signature of the human speaker and each of the authentication signatures stored in the template table in blocks 410 and 412 may be repeated until an authentication signature that has a sufficiently small difference from the signature of the human speaker is found and the identity of the human speaker is determined. For example, a determination may be made as to whether an additional authentication signature is available for comparison with the signature of the human speaker in block 420 if the current authentication signature is not a sufficiently close match to the signature of the human speaker. If an additional authentication signature is available, then the steps of determining the difference between the additional authentication signature and the signature of the human speaker in block 410 and determining whether the difference is sufficiently small in block 412 are repeated. If no additional authentication signature is available for comparison, the process concludes in block 418.

### Example Two

### Estimation of Direction Sound or Location of Sound Source

In this example, the audio and video features are transmitted to a neural network to estimate the direction of arrival of a sound or the location of a sound source based on both audio and video contents of a video clip. Although specific examples are described below for estimating the direction of arrival of a human speech or the location of a human speaker based on audio and video contents, the principles of the disclosed subject matter may also be applicable for estimating the direction or location of other types of sound sources, such as sources of sounds made by animals or machines. In one implementation, the estimation of the direction of arrival of a speech or the location of a speaker may involve two phases, including a first phase of using audio and video features for training a neural network to estimate the direction of arrival of the speech or the location of the speaker, as illustrated in FIG. 5, and a second phase of estimating the direction of arrival of the speech or the location of the speaker by using the trained neural network, as illustrated in FIG. 6.

FIG. 5 is a flowchart illustrating an example of a process in the first phase of training a neural network to estimate the direction of arrival of a speech or the location of a speaker. The process starts in block 502, and a video clip that is provided as a training video clip for training the neural network is read in block 504. In some instances, however, the training video clip may or may not contain a human speech. A determination may be made as to whether the training video clip contains a human speech in block 506.

If it is determined that the video clip contains a human speech in block 506, then a direction or location label may be assigned to the video clip, or at least to the speech portion of the video clip. In the example shown in FIG. 5, the direction or location label may be set to equal to the ground truth of the location of the speaker appearing in the video clip, that is, direction(location)_label=ground-truth_of_human-speaker_position, as shown in block 508, if a human speech is detected in the training video clip in block 506. In some implementations, the physical location of the speaker may be determined by the video content of the training video clip in which the speaker appears. The ground truth of the speaker position may be set at a point in space that is used as a reference point. On the other hand, if it is determined that the training video clip does not contain a human speech in block 506, then the direction or location label may be set to a value indicating that no human speech is detected in the training clip, for example, direction(location)_label=−1 or NULL, or another value indicating that no direction or location information may be derived from the training video clip, as shown in block 510.

After the direction or location label is determined, time-aligned audio and video features may be extracted from the training video clip in block 512, and the time-aligned audio and video features in each audio/video frame may be stored with a corresponding direction or location label in a table in block 514. In some implementations, the time-aligned audio and video features and their corresponding labels may be stored as key-value pairs, in which the labels are the keys and the audio and video features are the values, in a relational database, for example. In some implementations, the direction label may indicate the azimuth and elevation angles of the direction of sound propagation in three-dimensional spherical coordinates. In addition or as an alternative, the location of the human speaker in a given time-aligned audio/video frame may be provided as a label. For example, the location of the speaker may be expressed as the azimuth angle, the elevation angle, and the distance of the speaker with respect to a reference point which serves as the origin in three-dimensional spherical coordinates. Other types of three-dimensional coordinates such as Cartesian coordinates or cylindrical coordinates may also be used to indicate the location of the speaker.

In some instances, the speaker may remain at a fixed location in the training video clip, such that the location of the speaker may be used as a reference point or the ground truth for the label. In other instances, the speaker may move from one position to another in the training video clip, and the audio and video features within each time-aligned audio/video frame may be associated with a distinct label. The varying directions of sound propagation or the varying locations of the sound source in the training video clip may be tracked over time by distinct direction or location labels associated with their respective time-aligned audio/video frames in the table generated in block 514. As described above, the direction or location labels and their corresponding audio and video features in time-aligned audio/video frames may be stored as key-value pairs in a template table or a relational database, or in various other manners as long as the labels are correctly associated with their corresponding audio/video frames.

In FIG. 5, after the time-aligned audio and video features are stored along with their corresponding labels in a table in block 514, a determination is made as to whether an additional training video clip is available to be read in block 516. If an additional training video clip is available to be read, then the process steps as indicated in blocks 504-514 are repeated to generate additional time-aligned audio and video features and their associated labels and to store those features and labels in the table. If it is determined that no additional training video clip is available to be read in block 516, then the audio and video features and their associated labels stored in the table are used for training a neural network in block 518. The neural network may be a DNN with a combination of CNN and LSTM layers, for example. In some implementations, in addition or as an alternative to the DNN, the neural network may include one or more long-short-term memory (LSTM) layers, one or more convolutional neural network (CNN) layers, or one or more local contrast normalization (LCN) layers. In some instances, various types of filters such as infinite impulse response (IIR) filters, linear predictive filters, Kalman filters, or the like may be implemented in addition to or as part of one or more of the neural network layers. After the neural network has been trained with the audio and video features and their corresponding DOA or location labels, the training process concludes in block 520.

FIG. 6 is a flowchart illustrating an example of a process in the second phase of estimating the direction of arrival of a speech or the location of a speaker by using the neural network trained by the time-aligned audio and video features and their associated labels derived from one or more training video clips as shown in FIG. 5. In FIG. 6, the process starts in block 602, and a video clip containing a human speaker is read in block 604. The video clip that is read in block 604 of FIG. 6 is not a training video clip described with reference to FIG. 5, but is an actual video clip in which the direction of arrival of the speech or the location of the speaker is not pre-identified. Time-aligned audio and video features are extracted from the non-training video clip in block 606. In some implementations, the time-aligned audio and video features may be extracted from the non-training video clip in block 606 of FIG. 6 in a similar manner to the extraction of time-aligned audio and video features from the training video clip in block 512 of FIG. 5.

After the time-aligned audio and video features are extracted from the video clip in block 606, the audio and video features are passed through the neural network to obtain a maximum probability vector of the direction of the sound or speech, as shown in block 608. The maximum probability vector may be obtained by finding the closest match between the time-aligned audio and video features extracted from the non-training video clip obtained in FIG. 6 and the time-aligned audio and video features which are associated with corresponding direction or location labels derived from one or more training video clips and stored in a table or database in FIG. 5. Once the maximum probability vector is obtained, the estimated direction of the speech or the location of the speaker in the non-training video clip may be set to equal to the direction or location indicated by the label corresponding to the maximum probability vector, that is, direction(location)=speech_direction(location)_with_max_probability, as shown in block 610. After the estimated direction of arrival of the speech or the estimated location of the speaker in the non-training video clip is obtained in block 610, the process concludes in block 612.

In embodiments in which the direction of arrival of the speech is to be estimated, the probability vector may be a two-dimensional vector with one dimension representing an azimuth and the other dimension representing an elevation in spherical coordinates. In such embodiments, the maximum probability vector may be indicative of the highest likelihood of an exact or at least the closest match between the actual direction of arrival of the speech and one of the direction labels stored in a table or database, based on comparisons of the time-aligned audio and video features extracted from the non-training video clip in FIG. 6 to the time-aligned audio and video features stored along with their corresponding direction labels obtained from one or more training video clips in FIG. 5.

In embodiments in which the location of the speaker is to be estimated, the probability vector may be a three-dimensional vector with one dimension representing an azimuth, another dimension representing an elevation, and yet another dimension representing a distance in spherical coordinates. In such embodiments, the maximum probability vector may be indicative of the highest likelihood of an exact or at least the closest match between the actual location of the speaker and one of the location labels stored in a table or database, based on comparisons of the time-aligned audio and video features extracted from the non-training video clip in FIG. 6 to the time-aligned audio and video features stored along with their corresponding location labels obtained from one or more training video clips in FIG. 5. By using both audio and video features to estimate the direction of sound propagation or the location of the sound source, relatively accurate estimations of the direction or location may be obtained even if the audio content of the video clip may have been recorded in somewhat reverberant, noisy, or otherwise undesirable acoustic environments. Furthermore, ambiguities that may result from audio-only recordings made by microphone arrays may be avoided by taking advantage of video features that are time-aligned with the audio features according to embodiments of the disclosed subject matter.

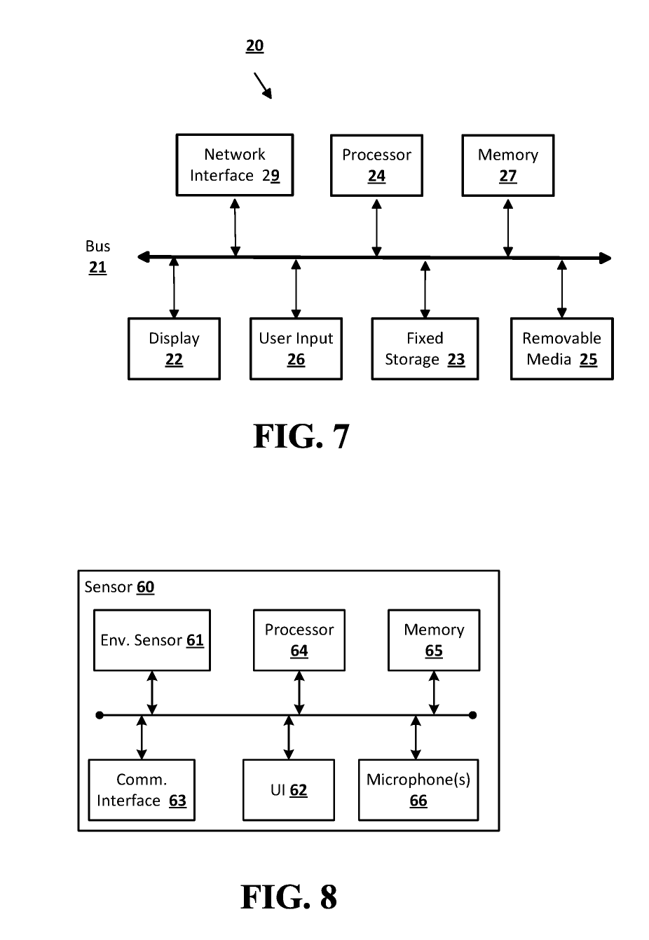

Embodiments of the presently disclosed subject matter may be implemented in and used with a variety of component and network architectures. For example, the neural network 16 as shown in FIG. 1 may include one or more computing devices for implementing embodiments of the subject matter described above. FIG. 7 shows an example of a computing device 20 suitable for implementing embodiments of the presently disclosed subject matter. The device 20 may be, for example, a desktop or laptop computer, or a mobile computing device such as a smart phone, tablet, or the like. The device 20 may include a bus 21 which interconnects major components of the computer 20, such as a central processor 24, a memory 27 such as Random Access Memory (RAM), Read Only Memory (ROM), flash RAM, or the like, a user display 22 such as a display screen, a user input interface 26, which may include one or more controllers and associated user input devices such as a keyboard, mouse, touch screen, and the like, a fixed storage 23 such as a hard drive, flash storage, and the like, a removable media component 25 operative to control and receive an optical disk, flash drive, and the like, and a network interface 29 operable to communicate with one or more remote devices via a suitable network connection.

The bus 21 allows data communication between the central processor 24 and one or more memory components, which may include RAM, ROM, and other memory, as previously noted. Typically RAM is the main memory into which an operating system and application programs are loaded. A ROM or flash memory component can contain, among other code, the Basic Input-Output system (BIOS) which controls basic hardware operation such as the interaction with peripheral components. Applications resident with the computer 20 are generally stored on and accessed via a computer readable medium, such as a hard disk drive (e.g., fixed storage 23), an optical drive, floppy disk, or other storage medium.

The fixed storage 23 may be integral with the computer 20 or may be separate and accessed through other interfaces. The network interface 29 may provide a direct connection to a remote server via a wired or wireless connection. The network interface 29 may provide such connection using any suitable technique and protocol as will be readily understood by one of skill in the art, including digital cellular telephone, Wi-Fi, Bluetooth®, near-field, and the like. For example, the network interface 29 may allow the computer to communicate with other computers via one or more local, wide-area, or other communication networks, as described in further detail below.

Many other devices or components (not shown) may be connected in a similar manner (e.g., document scanners, digital cameras and so on). Conversely, all of the components shown in FIG. 7 need not be present to practice the present disclosure. The components can be interconnected in different ways from that shown. The operation of a computer such as that shown in FIG. 7 readily known in the art and is not discussed in detail in this application. Code to implement the present disclosure can be stored in computer-readable storage media such as one or more of the memory 27, fixed storage 23, removable media 25, or on a remote storage location.

More generally, various embodiments of the presently disclosed subject matter may include or be embodied in the form of computer-implemented processes and apparatuses for practicing those processes. Embodiments also may be embodied in the form of a computer program product having computer program code containing instructions embodied in non-transitory or tangible media, such as floppy diskettes, CD-ROMs, hard drives, USB (universal serial bus) drives, or any other machine readable storage medium, such that when the computer program code is loaded into and executed by a computer, the computer becomes an apparatus for practicing embodiments of the disclosed subject matter. Embodiments also may be embodied in the form of computer program code, for example, whether stored in a storage medium, loaded into or executed by a computer, or transmitted over some transmission medium, such as over electrical wiring or cabling, through fiber optics, or via electromagnetic radiation, such that when the computer program code is loaded into and executed by a computer, the computer becomes an apparatus for practicing embodiments of the disclosed subject matter. When implemented on a general-purpose microprocessor, the computer program code segments configure the microprocessor to create specific logic circuits.

In some configurations, a set of computer-readable instructions stored on a computer-readable storage medium may be implemented by a general-purpose processor, which may transform the general-purpose processor or a device containing the general-purpose processor into a special-purpose device configured to implement or carry out the instructions. Embodiments may be implemented using hardware that may include a processor, such as a general purpose microprocessor or an Application Specific Integrated Circuit (ASIC) that embodies all or part of the techniques according to embodiments of the disclosed subject matter in hardware or firmware. The processor may be coupled to memory, such as RAM, ROM, flash memory, a hard disk or any other device capable of storing electronic information. The memory may store instructions adapted to be executed by the processor to perform the techniques according to embodiments of the disclosed subject matter.

In some embodiments, the microphones 10a and 10b as shown in FIG. 1 may be implemented as part of a network of sensors. These sensors may include microphones for sound detection, for example, and may also include other types of sensors. In general, a “sensor” may refer to any device that can obtain information about its environment. Sensors may be described by the type of information they collect. For example, sensor types as disclosed herein may include motion, smoke, carbon monoxide, proximity, temperature, time, physical orientation, acceleration, location, entry, presence, pressure, light, sound, and the like. A sensor also may be described in terms of the particular physical device that obtains the environmental information. For example, an accelerometer may obtain acceleration information, and thus may be used as a general motion sensor or an acceleration sensor. A sensor also may be described in terms of the specific hardware components used to implement the sensor. For example, a temperature sensor may include a thermistor, thermocouple, resistance temperature detector, integrated circuit temperature detector, or combinations thereof. A sensor also may be described in terms of a function or functions the sensor performs within an integrated sensor network, such as a smart home environment. For example, a sensor may operate as a security sensor when it is used to determine security events such as unauthorized entry. A sensor may operate with different functions at different times, such as where a motion sensor is used to control lighting in a smart home environment when an authorized user is present, and is used to alert to unauthorized or unexpected movement when no authorized user is present, or when an alarm system is in an “armed” state, or the like. In some cases, a sensor may operate as multiple sensor types sequentially or concurrently, such as where a temperature sensor is used to detect a change in temperature, as well as the presence of a person or animal. A sensor also may operate in different modes at the same or different times. For example, a sensor may be configured to operate in one mode during the day and another mode at night. As another example, a sensor may operate in different modes based upon a state of a home security system or a smart home environment, or as otherwise directed by such a system.

In general, a “sensor” as disclosed herein may include multiple sensors or sub-sensors, such as where a position sensor includes both a global positioning sensor (GPS) as well as a wireless network sensor, which provides data that can be correlated with known wireless networks to obtain location information. Multiple sensors may be arranged in a single physical housing, such as where a single device includes movement, temperature, magnetic, or other sensors. Such a housing also may be referred to as a sensor or a sensor device. For clarity, sensors are described with respect to the particular functions they perform or the particular physical hardware used, when such specification is necessary for understanding of the embodiments disclosed herein.

A sensor may include hardware in addition to the specific physical sensor that obtains information about the environment. FIG. 8 shows an example of a sensor as disclosed herein. The sensor 60 may include an environmental sensor 61, such as a temperature sensor, smoke sensor, carbon monoxide sensor, motion sensor, accelerometer, proximity sensor, passive infrared (PIR) sensor, magnetic field sensor, radio frequency (RF) sensor, light sensor, humidity sensor, pressure sensor, microphone, or any other suitable environmental sensor, that obtains a corresponding type of information about the environment in which the sensor 60 is located. A processor 64 may receive and analyze data obtained by the sensor 61, control operation of other components of the sensor 60, and process communication between the sensor and other devices. The processor 64 may execute instructions stored on a computer-readable memory 65. The memory 65 or another memory in the sensor 60 may also store environmental data obtained by the sensor 61. A communication interface 63, such as a Wi-Fi or other wireless interface, Ethernet or other local network interface, or the like may allow for communication by the sensor 60 with other devices. A user interface (UI) 62 may provide information or receive input from a user of the sensor. The UI 62 may include, for example, a speaker to output an audible alarm when an event is detected by the sensor 60. Alternatively, or in addition, the UI 62 may include a light to be activated when an event is detected by the sensor 60. The user interface may be relatively minimal, such as a limited-output display, or it may be a full-featured interface such as a touchscreen. Components within the sensor 60 may transmit and receive information to and from one another via an internal bus or other mechanism as will be readily understood by one of skill in the art. Furthermore, the sensor 60 may include one or more microphones 66 to detect sounds in the environment. One or more components may be implemented in a single physical arrangement, such as where multiple components are implemented on a single integrated circuit. Sensors as disclosed herein may include other components, or may not include all of the illustrative components shown.

Sensors as disclosed herein may operate within a communication network, such as a conventional wireless network, or a sensor-specific network through which sensors may communicate with one another or with dedicated other devices. In some configurations one or more sensors may provide information to one or more other sensors, to a central controller, or to any other device capable of communicating on a network with the one or more sensors. A central controller may be general- or special-purpose. For example, one type of central controller is a home automation network that collects and analyzes data from one or more sensors within the home. Another example of a central controller is a special-purpose controller that is dedicated to a subset of functions, such as a security controller that collects and analyzes sensor data primarily or exclusively as it relates to various security considerations for a location. A central controller may be located locally with respect to the sensors with which it communicates and from which it obtains sensor data, such as in the case where it is positioned within a home that includes a home automation or sensor network. Alternatively or in addition, a central controller as disclosed herein may be remote from the sensors, such as where the central controller is implemented as a cloud-based system that communicates with multiple sensors, which may be located at multiple locations and may be local or remote with respect to one another.

Moreover, the smart-home environment may make inferences about which individuals live in the home and are therefore users and which electronic devices are associated with those individuals. As such, the smart-home environment may “learn” who is a user (e.g., an authorized user) and permit the electronic devices associated with those individuals to control the network-connected smart devices of the smart-home environment, in some embodiments including sensors used by or within the smart-home environment. Various types of notices and other information may be provided to users via messages sent to one or more user electronic devices. For example, the messages can be sent via email, short message service (SMS), multimedia messaging service (MMS), unstructured supplementary service data (USSD), as well as any other type of messaging services or communication protocols.

A smart-home environment may include communication with devices outside of the smart-home environment but within a proximate geographical range of the home. For example, the smart-home environment may communicate information through the communication network or directly to a central server or cloud-computing system regarding detected movement or presence of people, animals, and any other objects and receives back commands for controlling the lighting accordingly.

The foregoing description, for purpose of explanation, has been described with reference to specific embodiments. However, the illustrative discussions above are not intended to be exhaustive or to limit embodiments of the disclosed subject matter to the precise forms disclosed. Many modifications and variations are possible in view of the above teachings. The embodiments were chosen and described in order to explain the principles of embodiments of the disclosed subject matter and their practical applications, to thereby enable others skilled in the art to utilize those embodiments as well as various embodiments with various modifications as may be suited to the particular use contemplated.

1. A method of determining an identity of a speaker, comprising:
extracting a first audio feature from a first audio content of a first video clip that includes a prescribed utterance of a first speaker who is identified by a speaker identifier;
extracting a first video feature from a first video content of the first video clip that includes an image of the first speaker;
obtaining an authentication signature based on the first audio feature and the first video feature;
extracting a second audio feature from a second audio content of a second video clip that includes an utterance of a second speaker who is not pre-identified;
extracting a second video feature from a second video content of the second video clip that includes an image of the second speaker;
obtaining a signature of the second speaker based on the second audio feature and the second video feature; and
determining whether the second speaker in the second video clip is the same as the first speaker in the first video clip based on a comparison between the signature of the second speaker and the authentication signature.

2. The method of claim 1, further comprising time-aligning the first audio feature and the first video feature prior to obtaining the authentication signature based on the first audio feature and the first video feature.

3. The method of claim 1, further comprising time-aligning the second audio feature and the second video feature prior to obtaining the signature of the second speaker based on the second audio feature and the second video feature.

4. The method of claim 1, wherein the speaker identifier is stored as a label.

5. The method of claim 4, wherein the authentication signature and the label are stored as a key-value pair comprising a key that includes the label and a value that includes the authentication signature.

6. The method of claim 1, wherein determining whether the second speaker in the second video clip is the same as the first speaker in the first video clip comprises determining a Hamming distance between the signature of the second speaker and the authentication signature.

7. The method of claim 6, wherein determining whether the second speaker in the second video clip is the same as the first speaker in the first video clip comprises determining that the second speaker in the second video clip is the same as the first speaker in the first video clip if the Hamming distance between the signature of the second speaker and the authentication signature is less than a threshold distance.

8. The method of claim 1, further comprising:
extracting a third audio feature from a third audio content of a third video clip that includes an additional prescribed utterance of the first speaker;
extracting a third video feature from a third video content of the third video clip that includes an additional image of the first speaker;
obtaining an additional authentication signature based on the third audio feature and the third video feature; and
determining whether the second speaker in the second video clip is the same as the first speaker in the third video clip based on a comparison between the signature of the second speaker and the additional authentication signature.

9. The method of claim 8, wherein determining whether the second speaker in the second video clip is the same as the first speaker in the third video clip comprises determining a Hamming distance between the signature of the second speaker and the additional authentication signature.

10. The method of claim 1, further comprising:
extracting a third audio feature from a third audio content of a third video clip that includes a prescribed utterance of a third speaker who is identified by a second speaker identifier;
extracting a third video feature from a third video content of the third video clip that includes an image of the third speaker;
obtaining an additional authentication signature based on the third audio feature and the third video feature; and
determining whether the second speaker in the second video clip is the same as the third speaker in the third video clip based on a comparison between the signature of the second speaker and the additional authentication signature.

11. The method of claim 10, wherein determining whether the second speaker in the second video clip is the same as the third speaker in the third video clip comprises determining a Hamming distance between the signature of the second speaker and the additional authentication signature.

12. An apparatus for determining an identity of a speaker, comprising:
a memory; and
a processor communicably coupled to the memory, the processor configured to execute instructions to:
extract a first audio feature from a first audio content of a first video clip that includes a prescribed utterance of a first speaker who is identified by a speaker identifier;
extract a first video feature from a first video content of the first video clip that includes an image of the first speaker;
obtain an authentication signature based on the first audio feature and the first video feature;
extract a second audio feature from a second audio content of a second video clip that includes an utterance of a second speaker who is not pre-identified;
extract a second video feature from a second video content of the second video clip that includes an image of the second speaker;
obtain a signature of the second speaker based on the second audio feature and the second video feature; and
determine whether the second speaker in the second video clip is the same as the first speaker in the first video clip based on a comparison between the signature of the second speaker and the authentication signature.

13. The apparatus of claim 12, wherein the speaker identifier is stored as a label.

14. The apparatus of claim 13, wherein the authentication signature and the label are stored as a key-value pair comprising a key that includes the label and a value that includes the authentication signature.

15. The apparatus of claim 12, wherein the instructions to determine whether the second speaker in the second video clip is the same as the first speaker in the first video clip comprise instructions to determine a Hamming distance between the signature of the second speaker and the authentication signature.

16. The apparatus of claim 15, wherein the instructions to determine whether the second speaker in the second video clip is the same as the first speaker in the first video clip comprise instructions to determine that the second speaker in the second video clip is the same as the first speaker in the first video clip if the Hamming distance between the signature of the second speaker and the authentication signature is less than a threshold distance.

17. The apparatus of claim 12, wherein the processor is further configured to execute instructions to:
extract a third audio feature from a third audio content of a third video clip that includes an additional prescribed utterance of the first speaker;
extract a third video feature from a third video content of the third video clip that includes an additional image of the first speaker;
obtain an additional authentication signature based on the third audio feature and the third video feature; and
determine whether the second speaker in the second video clip is the same as the first speaker in the third video clip based on a comparison between the signature of the second speaker and the additional authentication signature.

18. The apparatus of claim 12, wherein the processor is further configured to execute instructions to:
extract a third audio feature from a third audio content of a third video clip that includes a prescribed utterance of a third speaker who is identified by a second speaker identifier;
extract a third video feature from a third video content of the third video clip that includes an image of the third speaker;
obtain an additional authentication signature based on the third audio feature and the third video feature; and
determine whether the second speaker in the second video clip is the same as the third speaker in the third video clip based on a comparison between the signature of the second speaker and the additional authentication signature.

19. A method of estimating a direction of a sound, comprising:
extracting a first audio feature from a first audio content of a first video clip;
extracting a first video feature from a first video content of the first video clip;
determining a label indicating at least a direction of a first sound from a sound source in the first video clip based on the first audio feature and the first video feature;
extracting a second audio feature from a second audio content of a second video clip that includes a second sound from the sound source, wherein the direction of the second sound is not pre-identified;
extracting a second video feature from a second video content of the second video clip; and
obtaining a probable direction of the second sound based on a comparison of the second audio feature to the first audio feature and a comparison of the second video feature to the first video feature.

20. The method of claim 19, further comprising:
extracting one or more additional audio features from one or more additional video clips;
extracting one or more additional video features from said one or more additional video clips;
determining one or more additional labels indicating at least one or more additional directions of one or more additional sounds from the sound source in said one or more additional video clips based on said one or more additional audio features and said one or more additional video features; and
obtaining a probable direction of the second sound based on a closest match of the second audio feature to one of said one or more additional audio features or a closest match of the second video feature to one of said one or more additional video features.

21. The method of claim 19, wherein the label indicates a location of the sound source in the first video clip based on the first audio feature and the first video feature.

22. The method of claim 21, further comprising obtaining a probable location of the sound source for the second sound in the second video clip based on a comparison of the second audio feature to the first audio feature and a comparison of the second video feature to the first video feature.

23. The method of claim 22, further comprising:
extracting one or more additional audio features from one or more additional video clips;
extracting one or more additional video features from said one or more additional video clips;
determining one or more additional labels indicating at least one or more additional locations of one or more additional sounds from the sound source in said one or more additional video clips based on said one or more additional audio features and said one or more additional video features; and
obtaining a probable location of the second sound based on a closest match of the second audio feature to one of said one or more additional audio features or a closest match of the second video feature to one of said one or more additional video features.

24. An apparatus for estimating a direction of a sound, comprising:
a memory; and
a processor communicably coupled to the memory, the processor configured to execute instructions to:
extract a first audio feature from a first audio content of a first video clip;
extract a first video feature from a first video content of the first video clip;
determine a label indicating at least a direction of a first sound from a sound source in the first video clip based on the first audio feature and the first video feature;
extract a second audio feature from a second audio content of a second video clip that includes a second sound from the sound source, wherein the direction of the second sound is not pre-identified;
extract a second video feature from a second video content of the second video clip; and
obtain a probable direction of the second sound based on a comparison of the second audio feature to the first audio feature and a comparison of the second video feature to the first video feature.

25. The apparatus of claim 24, wherein the processor is further configured to execute instructions to:
extract one or more additional audio features from one or more additional video clips;
extract one or more additional video features from said one or more additional video clips;
determine one or more additional labels indicating at least one or more additional directions of one or more additional sounds from the sound source in said one or more additional video clips based on said one or more additional audio features and said one or more additional video features; and
obtain a probable direction of the second sound based on a closest match of the second audio feature to one of said one or more additional audio features or a closest match of the second video feature to one of said one or more additional video features.

26. The apparatus of claim 24, wherein the label indicates a location of the sound source in the first video clip based on the first audio feature and the first video feature.

27. The apparatus of claim 26, wherein the processor is further configured to execute instructions to obtain a probable location of the sound source for the second sound in the second video clip based on a comparison of the second audio feature to the first audio feature and a comparison of the second video feature to the first video feature.

28. The apparatus of claim 27, wherein the processor is further configured to execute instructions to:
extract one or more additional audio features from one or more additional video clips;
extract one or more additional video features from said one or more additional video clips;
determine one or more additional labels indicating at least one or more additional locations of one or more additional sounds from the sound source in said one or more additional video clips based on said one or more additional audio features and said one or more additional video features; and
obtain a probable location of the second sound based on a closest match of the second audio feature to one of said one or more additional audio features or a closest match of the second video feature to one of said one or more additional video features.
